(19) United States
(12) Patent Application Publication
(10) Pub. No.: US 2005/0249837 A1
(43) Pub. Date: Nov. 10, 2005

(54) Processes for preparing plant matter extracts and pet food compositions

(75) Inventors: Stefan Patrick Massimino, Kettering, OH (US); Raymond Louis Niehoff, Hamilton, OH (US); Robert Joseph Sarama, Loveland, OH (US); Ronald Eugene Tribelhorn, Clayton, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignees: The Procter & Gamble Company, Cincinnati, OH (US); The IAMS Company

(21) Appl. No.: 10/842,300

(22) Filed: May 10, 2004

(51) Int. Cl. A23K 1/00

(52) U.S. Cl. 426/52

(57) ABSTRACT

Disclosed herein are processes for preparing a plant matter extract, as well as food compositions comprising such extracts. The plant matter is selected from avocado, alfalfa, fig, primrose, and mixtures thereof. The processes include providing plant matter selected from the group consisting of avocado, alfalfa, fig, primrose, and mixtures thereof; combining the plant matter with an aqueous solution and optionally with an enzyme, further optionally with heating, to provide a digested plant mixture; concentrating the digested plant mixture to enhance the concentration of carbohydrate therein. The processes for preparing food compositions further include combining the digested plant mixture with one or more food composition components.

### FIELD OF THE INVENTION

The present invention is directed to processes for preparing a plant extract, including processes for preparing pet food compositions containing such extracts. In certain embodiments, the extracts or pet food compositions prepared thereby may comprise a selected carbohydrate component, or a plant material selected from avocado, alfalfa, fig, primrose, and mixtures thereof.

### BACKGROUND OF THE INVENTION

Studies have indicated that restriction of caloric intake by food deprivation slows down certain undesirable cellular processes in laboratory animals, many associated with aging and age-related diseases.

In particular, caloric restriction has been shown to consistently extend the life span, delay onset and slow tumor progression, and retard physiologic aging in many systems. Indeed, research spanning more than sixty years has shown that caloric restriction is a nutritional intervention that consistently extends longevity in animals. See Weindruch and Walford, “The Retardation of Aging and Disease by Dietary Restriction,” Springfield, Ill.: Charles C. Thomas (1988); Yu, “Modulation of Aging Processes by Dietary Restriction,” Boca Raton: CRC Press (1994); and Fishbein, “Biological Effects of Dietary Restriction,” Springer, New York (1991). These effects of caloric restriction on life span and tumorigenesis have been reported numerous times since the early studies of McKay. See McKay et al., “The Effect of Retarded Growth Upon the Length of Lifespan and Upon Ultimate Body Size,” J. Nutr., Vol. 10, pp. 63-79 (1935). Indeed, over the past two decades, a resurgence of interest in caloric restriction in gerontology has led to the general acceptance that this dietary manipulation slows physiologic aging in many systems. See Weindruch and Walford, “The Retardation of Aging and Disease by Dietary Restriction,” Springfield, Ill.: Charles C. Thomas (1988); Yu, “Modulation of Aging Processes by Dietary Restriction,” Boca Raton: CRC Press (1994); and Fishbein, “Biological Effects of Dietary Restriction,” Springer, New York (1991).

Reductions in fasting glucose and insulin levels are readily measured biomarkers of caloric restriction. Calorically restricted rodents exhibit lower fasting glucose and insulin levels, and the peak glucose and insulin levels reached during a glucose challenge are reduced in those on caloric restriction. See Kalant et al., “Effect of Diet Restriction on Glucose Metabolism and Insulin Repsonsiveness and Aging Rats,” Mech. Aging Dev., Vol. 46, pp. 89-104 (1988). It is also known that hyperinsulinemia is a risk factor associated with several such disease processes, including heart disease and diabetes (Balkau and Eschwege, Diabetes Obes. Metab. 1 (Suppl. 1): S23-31, 1999). Reduced insulin levels and body temperature are two of the most reliable indicators of this altered metabolic profile (Masoro et al., J. Gerontol. Biol. Sci. 47:B202-B208, 1992); Koizumi et al., J. Nutr. 117: 361-367, 1987; Lane et al., Proc. Nat. Acad. Sci. 93:4154-4164, 1996).

Components such as 2-deoxy-D-glucose have been described which block or inhibit certain aspects of carbohydrate metabolism and may therefore mimic the effects of caloric restriction (Rezek et al., J. Nutr. 106:143-157, 1972; U.S. Patent Application Publication No. 2002/0035071). These components exert a number of physiological effects, including reduction of body weight, decrease in plasma insulin levels, reduction of body temperature, retardation of tumor formation and growth, and elevation of circulating glucocorticoid hormone concentrations. (For a review see Roth et al., Ann. NY Acad. Sci. 928:305-315, 2001). These effects result from inhibition of carbohydrate metabolism.

However, the commercial utility of such components has been limited, particularly since commercial processes of preparing such components had yet been identified. The present inventors herein provide processes for preparation of compositions comprising a plant matter extract containing such a component. In particular, it has been found that the components herein may be processed from plant matter, and then optionally subjected to traditional food processing (such as, for example, extrusion or other such vigorous methods) without compromising the integrity of the component.

### SUMMARY OF THE INVENTION

The present invention is directed to processes for preparing a plant matter extract and, separately processes for preparing a food composition by providing plant matter.

The processes for preparing a plant matter extract comprise:
(a) providing plant matter selected from the group consisting of avocado, alfalfa, fig, primrose, and mixtures thereof;
(b) combining the plant matter with an aqueous solution and optionally with an enzyme, further optionally with heating, to provide a digested plant mixture; and
(c) concentrating the digested plant mixture to enhance the concentration of carbohydrate therein.

The processes for preparing a food composition comprising a plant matter extract comprise:
(a) providing plant matter selected from the group consisting of avocado, alfalfa, fig, primrose, and mixtures thereof;
(b) combining the plant matter with an aqueous solution and optionally with an enzyme, further optionally with heating, to provide a digested plant mixture;
(c) concentrating the digested plant mixture to enhance the concentration of carbohydrate therein; and
(d) combining the digested plant mixture with one or more food composition components.

### DETAILED DESCRIPTION OF THE INVENTION

Various documents including, for example, publications and patents, are recited throughout this disclosure. All such documents are hereby incorporated by reference. The citation of any given document is not to be construed as an admission that it is prior art with respect to the present invention.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the features or embodiments as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

As used herein, the term “pet” means a domestic dog or cat.

### Processes of the Present Invention

The present invention is directed to processes for preparing a plant matter extract and, separately processes for preparing a food composition by providing plant matter. In one embodiment, the food composition is a pet food composition.

The processes for preparing a plant matter extract comprise:
(a) providing plant matter selected from the group consisting of avocado, alfalfa, fig, primrose, and mixtures thereof;
(b) combining the plant matter with an aqueous solution and optionally with an enzyme, further optionally with heating, to provide a digested plant mixture; and
(c) concentrating the digested plant mixture to enhance the concentration of carbohydrate therein.

The processes for preparing a food composition comprising a plant matter extract comprise:
(a) providing plant matter selected from the group consisting of avocado, alfalfa, fig, primrose, and mixtures thereof;
(b) combining the plant matter with an aqueous solution and optionally with an enzyme, further optionally with heating, to provide a digested plant mixture;
(c) concentrating the digested plant mixture to enhance the concentration of carbohydrate therein; and
(d) combining the digested plant mixture with one or more food composition components.

The plant matter provided in the various processes may be avocado, alfalfa, fig, primrose, and mixtures thereof. These plants are known to contain carbohydrate components such as 2-deoxy-D-glucose, 5-thio-D-glucose, 3-O-methylglucose, 1,5-anhydro-D-glucitol, 2,5-anhydro-D-mannitol, or mannoheptulose. See e.g., U.S. Patent Application Publication No. 2002/0035071. Processes resulting in extracts which have elevated concentrations of mannoheptulose are preferred herein. Advantageously, the mannoheptulose or any other component may be present as a component of plant matter such as avocado, or other enriched source of mannoheptulose such as alfalfa, fig, or primrose.

The plant matter may be any portion or whole of the plant, such as the leaves, fruit, seed or pit, particularly at least those portions of the plant that contain elevated levels of carbohydrate component. The inclusion of one or more of these components as part of the extracts of food compositions herein are useful, for example, to alter utilization of glucose or other energy sources and to mimic metabolic effects of caloric restriction. Without intending to be limited by theory, the present use of glucose anti-metabolites to alter glucose metabolism serves to lower the metabolic rate through inhibition of glucose as an energy source on the cellular level. Judicious use of components that block the normal metabolism of cellular glucose can result in changes in physiological function that are similar to those arising from caloric restriction. Caloric restriction has been consistently shown to extend longevity in animals. See Weindruch and Walford, “The Retardation of Aging and Disease by Dietary Restriction,” Springfield, Ill.: Charles C. Thomas (1988); Yu, “Modulation of Aging Processes by Dietary Restriction,” Boca Raton: CRC Press (1994); and Fishbein, “Biological Effects of Dietary Restriction,” Springer, New York (1991).

The plant matter may include the fruit, seed (or pit), branches, leaves, or any other portion of the relevant plant or combination thereof. For example, in one embodiment herein, the avocado is provided, and the process may commence with whole or partial avocado fruit, including the pit or devoid (or partially devoid) of the pit. If the plant matter which is provided contains a pit, or partial pit, the pit or portion thereof may be optionally removed prior to further processing. Alfalfa, fig, or primrose may be similarly processed.

Avocado (also commonly referred to as alligator pear, aguacate, or palta) contains unusually enriched sources of mannoheptulose, as well as related sugars and other carbohydrate components. Avocado is a sub-tropical evergreen tree fruit, growing most successfully in areas of California, Florida, Hawaii, Guatemala, Mexico, the West Indies, South Africa, and Asia.

Species of avocado include, for example, Persea Americana and Persea nubigena, including all cultivars within these illustrative species. Cultivars may include ‘Anaheim,’ ‘Bacon,’ ‘Creamhart,’ ‘Duke,’ ‘Fuerte,’ ‘Ganter,’ ‘Gwen,’ ‘Hass,’ ‘Jim,’ ‘Lula,’ ‘Lyon,’ ‘Mexicola,’ ‘Mexicola Grande,’ ‘Murrieta Green,’ ‘Nabal,’ ‘Pinkerton,’ ‘Queen,’ ‘Puebla,’ ‘Reed,’ ‘Rincon,’ ‘Ryan,’ ‘Spinks,’ ‘Topa Topa,’ ‘Whitsell,’ ‘Wurtz,’ and ‘Zutano.’ The fruit of the avocado is particularly preferred for use herein, which may contain the pit or wherein the pit is removed or at least partially removed. Fruit from Persea Americana is particularly preferred for use herein, as well as fruit from cultivars which produce larger fruits (e.g., about 12 ounces or more when the fruit is mature), such as Anaheim, Creamhart, Fuerte, Hass, Lula, Lyon, Murrieta Green, Nabal, Queen, Puebla, Reed, Ryan, and Spinks.

Plant matter from alfalfa, fig, or primrose are also reported to provide relatively high levels of mannoheptulose. Alfalfa is also referred to as Medicago sativa. Fig, or Ficus carica (including Cluster fig or Sycamore fig, for example) may also be used, as well as primrose or Primula officinalis.

In one embodiment, production of a digested plant mixture comprises combination of the plant matter with an aqueous solution, such as water, to assist with maceration of the plant into manageable constituents. Optionally but preferably, an enzyme having cellulose or pectin activity, or any combination thereof (such as a cellulase, hemicellulase, or pectinase) is included to assist with such maceration, including to assist with dissolution and release of carbohydrates via cell wall disruption. The utility of such an enzymatic treatment may be enhanced through heating during such maceration, such as from above ambient temperature to about 120° C., or to about 100° C., or from about 60° C. to about 120° C., or from about 60° C. to about 100° C. Agitation is further preferably utilized, typically for up to about 24 hours, but dependent upon the batch under processing. In one embodiment, the pH is controlled such to preserve enzyme activity, often in the range of pH from about 4 to about 6, preferably in the range of pH from about 5 to about 6. As such, depending upon such factors as ripeness of plant matter, quality of process aqueous solution (such as water added for process, for example), and the like, amounts of acid or base may be desirable as will be appreciated by one of ordinary skill in the art.

Optionally, to assist with deactivation of the enzymes present, heating may be increased at the time of, or after, initial heating and agitation to form the digested plant mixture. Water is optionally heated to processing temperatures prior to the addition of the plant matter. Heat may be applied by a jacketed tank where low pressure steam is utilized.

The digested plant mixture may result in fractions which may be separated in accordance with common techniques. For example, fractions present in the digested plant mixture may be separated by filtration to provide the carbohydrate extract as the resulting filtrate, with the filter cake being discarded. Other methods may include, but not be limited to, gravimetric, centrifugal, other filtrations, or combinations thereof.

The carbohydrate extract may then be concentrated, optionally utilizing at least one concentration method selected from the group consisting of heating, vacuum drying, evaporation, refractance window drying, freeze drying, spray drying, any other useful technique, or any combination of the foregoing. In one embodiment, at least one technique such as refractance window drying is used.

Once concentrated, the carbohydrate extract may be utilized in the pet food compositions of the present invention. In one embodiment herein, the present processes result in preferred yields of mannoheptulose or other carbohydrate, or carbohydrate extract, based on the starting mass of the plant matter (e.g., avocado). In one embodiment, the yield of mannoheptulose present in the carbohydrate extract subsequent to concentration is less than about 20%, or from about 0.1% to about 10%, or from about 1% to about 7%, based on the starting mass of the plant matter. In another embodiment, the yield of the carbohydrate extract subsequent to concentration is less than about 30%, or from about 5% to about 25%, or from about 8% to about 20%, based on the starting mass of the plant matter. Of course, even higher yields may be desirable, and lower yields may also be acceptable.

Food compositions may be prepared in accordance with the present processes by further including combining the digested plant mixture with one or more food composition components. As used herein, the term “food composition” means a composition that is intended for ingestion by an animal, such as a human, or other animal (including a pet). For example, a pet food composition is a food composition that is intended for ingestion by a pet. Food compositions are widely known in the art. Pet food compositions may include, without limitation, nutritionally balanced compositions suitable for daily feed, as well as supplements (e.g., treats) which may or may not be nutritionally balanced. As used herein, the term “nutritionally balanced,” with reference to the pet food composition, means that the composition has known required nutrients to sustain life in proper amounts and proportion based on recommendations of recognized authorities in the field of pet nutrition.

In one embodiment herein, the inventive processes are utilized to prepare a food composition comprising a component selected from 2-deoxy-D-glucose; 5-thio-D-glucose; 3-O-methylglucose; 1,5-anhydro-D-glucitol; 2,5-anhydro-D-mannitol; mannoheptulose; and mixtures thereof. In a further embodiment, such component is present in the prepared composition at particular levels. In particular, it has been found that relatively low levels, as well as relatively high doses of the component, while useful, may provide less than optimal efficacy for desired purposes. In particular, an optimal dose to the pet, on a daily basis, has been surprisingly discovered to be from about 1 mg/kg to about 15 mg/kg, more advantageously from about 2 mg/kg to about 10 mg/kg, even more advantageously from about 2 mg/kg to about 5 mg/kg, wherein (as will be commonly understood in the art) the “mg” refers to level of the component and the “kg” refers to kilograms of the pet. In certain embodiments, this may translate to preparation of pet food compositions comprising less than about 5%, or less than about 2%, or from about 0.0001% to about 0.5% of the component, all by weight of the composition. The level of component may be determined by one of ordinary skill in the art based on a variety of factors, for example, the form of the pet food composition (e.g., whether a dry composition, semi-moist composition, wet composition, or supplement, or any other form or mixture thereof). The ordinarily skilled artisan will be able to utilize the preferred optimal doses, and use these to determine the optimal level of component within a given pet food composition.

Similarly, optimal levels of plant matter extract will of course be dependent upon level of efficacious component within such extract. Optimal extracts have been found herein which comprise from about 1% to about 99% of the component, alternatively from about 5% to about 75% of the component, alternatively from about 10% to about 50% of the component, all by weight of the extract.

Food compositions will contain one or more food composition components, which will of course be widely known in the art.

For example, pet food compositions may advantageously include food composition components intended to supply necessary dietary requirements, as well as treats (e.g., dog biscuits) or other food supplements. Optionally, the composition herein may be a pet food composition such as a dry composition (for example, kibble), semi-moist composition, wet composition, or any mixture thereof. Alternatively or additionally, the composition is a supplement, such as a gravy, drinking water, yogurt, powder, suspension, chew, treat (e.g., biscuits) or any other delivery form.

In one embodiment, the food compositions may comprise, on a dry matter basis, from about 10% to about 90% crude protein, alternatively from about 20% to about 50% crude protein, alternatively from about 20% to about 40% crude protein, by weight of the food composition, or alternatively from about 20% to about 35% crude protein. The crude protein material may comprise vegetable proteins such as soybean, cottonseed, and peanut, or animal proteins such as casein, albumin, and meat protein. Non-limiting examples of meat protein useful herein include a protein source selected from the group consisting of beef, pork, lamb, poultry, fish, vegetable, and mixtures thereof.

Furthermore, the compositions may comprise, on a dry matter basis, from about 5% to about 40% fat, alternatively from about 10% to about 35% fat, by weight of the food composition.

The compositions of the present invention may further comprise a source of carbohydrate. Grains or cereals such as rice, corn, milo, sorghum, barley, wheat, and the like are illustrative sources.

The compositions may also contain one or more other materials such as dried whey and other dairy by products.

### EXAMPLES

The following examples are provided to illustrate the invention and are not intended to limit the scope thereof in any manner.

### Example 1

Avocado extract containing enhanced levels of mannoheptulose is prepared in accordance with the following process, and utilized in pet food compositions:

Whole avocado fruit (about 900 kilograms) is provided. The fruit is split and the pits are removed, either partially or wholly, providing about 225 kilograms of pitted avocado halves. The raw avocado is charged to a disintegrator, whereupon some agitation, water (about 3000 kilograms) and CELLUBRIX (commercially available from Novozymes A/S) (about 1 liter) is further charged. The mixture is further agitated and concurrently heated to about 66° C. Upon completion of the charge, further CELLUBRIX (about 1 liter) is added, and the entire mixture is held under agitation for about 12 hours at a controlled pH of about 5.5. The temperature is then further increased to about 80° C. and then held for at least about 2 hours. The resulting digested plant mixture is then filtered at 80° C. to provide the carbohydrate extract as the filtrate. The carbohydrate extract is then evaporated in a simplified recirculation system at 80° C., under vacuum, to a provide the carbohydrate extract having about from about 10% to about 20% solids and a pH of about 5.5. The extract is then further concentrated using a refractance window dryer to provide about 100 kilograms of the extract as a crystalline or powder (a yield of about 11% carbohydrate extract, based on the starting mass of the whole avocado fruit, which is analyzed as a yield of about 4.5% mannoheptulose, based on the starting mass of the whole avocado fruit). The extract may be used in the pet food compositions of the present invention.

### Example 2

Two kibble compositions having the following components at the approximate indicated amounts are prepared using methods which are standard in the art, including extrusion, and are fed to cats as a daily feed:

| | Example 1A | Example 1B |
|---|---|---|
| | (Component Amount | (Component Amount |
| Component | indicated as Wt %) | indicated as Wt %) |
| Extract of Avocado | 0.02 | 0.01 |
| Prepared in Accordance | | |
| with Present Invention | | |
| Chicken, Chicken | 44 | 47 |
| By-product Meal | | |
| Fish Meal | | |
| Chicken Fat | 8 | 6 |
| Beet Pulp | 2 | 3 |
| Salts | 2.5 | 2 |
| Vitamins and Minerals** | 1 | 1 |
| Minors | 3.5 | 4 |
| Grains | Remainder | Remainder |
| (corn, sorghum) | | |

*Avocado may be substituted with other plant matter having enhanced mannoheptulose content.
**Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

### Example 3

A beef-flavor gravy composition is prepared by combining the following components in a conventional manner:

| Component | Wt % |
|---|---|
| Extract of Avocado Prepared in | 0.14 |
| Accordance with Present Invention | |
| Chicken Fat | 3.0 |
| Spray-Dried Beef Particles and Broth | 3.0 |
| Xanthan Gum | 0.5 |
| Flax Seed | 0.2 |
| Vegetables | 0.2 |
| Vitamins** | 0.06 |
| Minerals | 0.04 |
| Phosphoric Acid | 0.95 |
| Beef Flavor | 0.1 |
| Water | Remainder |

**Vitamins and Minerals include: Vitamin E, beta-carotene and Vitamin A, Zinc Oxide, Ascorbic Acid, Manganese Sulfate, Copper Sulfate, Manganous Oxide, Calcium Pantothenate, Biotin, Vitamin B₁₂, Vitamin B₁, Niacin, Vitamin B₂, Vitamin B₆, Vitamin D₃, Folic Acid.

One fluid ounce of the gravy composition is admixed with one-half cup of standard dog kibble diet daily prior to feeding to a dog. Amounts of the gravy composition are determined as desired by the guardian of the dog.

1. A process for preparing a plant matter extract comprising:
(a) providing plant matter selected from the group consisting of avocado, alfalfa, fig, primrose, and mixtures thereof;
(b) combining the plant matter with an aqueous solution and optionally with an enzyme, further optionally with heating, to provide a digested plant mixture; and
(c) concentrating the digested plant mixture to enhance the concentration of carbohydrate therein.

2. The process according to claim 1 wherein the plant matter comprises fruit of avocado and is combined with the aqueous solution and the enzyme, with heating, to provide the digested plant mixture.

3. The process according to claim 2 wherein the heating is at a temperature which is from above ambient temperature to about 120° C.

4. The process according to claim 3 further comprising separating fractions present in the digested plant mixture, if any, to provide the carbohydrate extract.

5. The process according to claim 4 wherein subsequent to providing the plant matter, wherein the fruit of avocado comprises a pit, the process further comprises at least partially removing the pit.

6. The process according to claim 5 wherein the enzyme is a cellulase enzyme.

7. The process according to claim 6 wherein the heating is at a temperature which is from about 60° C. to about 100° C.

8. The process according to claim 7 wherein fractions present in the digested plant mixture are separated by filtration to provide the carbohydrate extract as the resulting filtrate.

9. The process according to claim 8 wherein the carbohydrate extract is concentrated utilizing at least one concentration method selected from the group consisting of heating, vacuum drying, refractance window drying, freeze drying, and spray drying.

10. The process according to claim 9 wherein the carbohydrate extract is concentrated utilizing at least one concentration method which is refractance window drying.

11. The process according to claim 10 wherein the yield of mannoheptulose present in the plant matter extract is less than about 20%, based on the starting mass of the plant matter.

12. The process according to claim 11 wherein the yield of mannoheptulose present in the plant matter extract is from about 0.1% to about 10%, based on the starting mass of the plant matter.

13. The process according to claim 12 wherein the yield of mannoheptulose present in the plant matter extract is from about 1% to about 7%, based on the starting mass of the plant matter.

14. The process according to claim 10 wherein the yield of the plant matter extract is less than about 30%, based on the starting mass of the plant matter.

15. The process according to claim 14 wherein the yield of the plant matter extract is from about 5% to about 25%, based on the starting mass of the plant matter.

16. The process according to claim 15 wherein the yield of the plant matter extract is from about 8% to about 20%, based on the starting mass of the plant matter.

17. A process for preparing a food composition comprising:
(a) providing plant matter selected from the group consisting of avocado, alfalfa, fig, primrose, and mixtures thereof;
(b) combining the plant matter with an aqueous solution and optionally with an enzyme, further optionally with heating, to provide a digested plant mixture;
(c) concentrating the digested plant mixture to enhance the concentration of carbohydrate therein; and
(d) combining the digested plant mixture with one or more food composition components.

18. The process according to claim 17 wherein the food composition is a pet food composition.

19. The process according to claim 18 wherein the plant matter comprises fruit of avocado and is combined with the aqueous solution and the enzyme, with heating, to provide the digested plant mixture.

20. The process according to claim 19 wherein the heating is at a temperature which is from above ambient temperature to about 120° C.

21. The process according to claim 20 further comprising separating fractions present in the digested plant mixture, if any, to provide the carbohydrate extract.

22. The process according to claim 21 wherein subsequent to providing the plant matter, wherein the fruit of avocado comprises a pit, the process further comprises at least partially removing the pit.

23. The process according to claim 22 wherein the enzyme is a cellulase enzyme.

24. The process according to claim 23 wherein the heating is at a temperature which is from about 60° C. to about 100° C.

25. The process according to claim 24 wherein fractions present in the digested plant mixture are separated by filtration to provide the carbohydrate extract as the resulting filtrate.

26. The process according to claim 25 wherein the carbohydrate extract is concentrated utilizing at least one concentration method selected from the group consisting of heating, vacuum drying, refractance window drying, freeze drying, and spray drying.

27. The process according to claim 26 wherein the carbohydrate extract is concentrated utilizing at least one concentration method which is refractance window drying.

28. The process according to claim 27 wherein the yield of mannoheptulose present in the carbohydrate extract subsequent to concentration is less than about 20%, based on the starting mass of the plant matter.

29. The process according to claim 28 wherein the yield of mannoheptulose present in the digested plant mixture subsequent to concentration is from about 0.1% to about 10%, based on the starting mass of the plant matter.

30. The process according to claim 29 wherein the yield of mannoheptulose present in the digested plant mixture subsequent to concentration is from about 1% to about 7%, based on the starting mass of the plant matter.

31. The process according to claim 27 wherein the yield of the digested plant mixture subsequent to concentration is less than about 30%, based on the starting mass of the plant matter.

32. The process according to claim 31 wherein the yield of the digested plant mixture subsequent to concentration is from about 5% to about 25%, based on the starting mass of the plant matter.

33. The process according to claim 32 wherein the yield of the digested plant mixture subsequent to concentration is from about 8% to about 20%, based on the starting mass of the plant matter.

34. The process according to claim 27 wherein the pet food composition is a dog food composition.

35. The process according to claim 27 wherein the pet food composition is a cat food composition.
